(19) United States
(12) Patent Application Publication
(10) Pub. No.: US 2009/0101262 A1
(43) Pub. Date: Apr. 23, 2009

(54) Wheel and tire assembly with non-matching seat diameters whereof the tire comprises sidewalls wider than the rim

(75) Inventors: Nicolas Janin, Riom (FR); Guy Cagneaux, Nohanent (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUES S.A., GRANGES-PACCOTT (CH)

(21) Appl. No.: 11/989,473

(22) PCT Filed: Jul. 3, 2006
(86) PCT No.: PCT/EP2006/063819

§ 371 Date: Jan. 25, 2008

(30) Foreign Application Priority Data
Jul. 28, 2005 (FR) 0508090

(51) Int. Cl. B60C 3/04

(52) U.S. Cl. 152/454

(57) ABSTRACT

Assembly comprising a vehicle wheel, with symmetry of revolution, comprising a disc and a rim, the said rim comprising a first and a second seat which seats are intended to receive and to hold a first and a second bead of the tire, each seat having a substantially frustoconical bottom locally coinciding with a cone of revolution coaxial with the rim and open towards the other seat, the said rim defining, at the level of an axial straight line passing through the farthermost points of the outer portions, a width Lj and, on the other hand, a tire for a vehicle wheel, comprising two sidewalls spaced axially apart and defining, at the level of an axial straight line passing through the farthermost points, a width Lf, in which when the said tire is mounted on the said rim and inflated close to its nominal working pressure and when the said tire is substantially unflattened, the said width Lf is greater than the said width Lj.

The invention relates to an assembly for a vehicle comprising a wheel and a tire with seats of unequal diameters.

Application WO 01/08905 describes a vehicle wheel with seats of unequal diameters and an assembly consisting of such a wheel and of a support insert. The vehicle wheel set out in that document, which has symmetry of revolution, is intended for mounting a tire and a tread support insert and comprises a disc and a rim. The rim is such that it comprises:
a first and a second seat which seats are intended to receive and to hold a first and a second bead of the tire, each seat having a substantially frustoconical bottom locally coinciding with a cone of revolution coaxial with the rim and open towards the other seat, a safety hump extending the bottom of the seat towards the other seat, and an external flange extending the bottom of the seat in the direction away from the other seat, and the maximum diameter of the first seat being shorter than the maximum diameter of the second seat; and
from the first seat towards the second seat, a first circumferential groove, a bearing surface of a diameter that is substantially equal to the maximum diameter of the first seat and a second circumferential groove.

This wheel is such that the disc is connected to the rim on the first seat side.

The wheel and the wheel/insert assembly set out in that document are able to run flat under excellent conditions, particularly with very low risk of the tire beads becoming unseated. Furthermore, this type of assembly has a width which is less at the sidewalls than at the external flange of the rim. The rim is therefore liable to be knocked or subjected to external attack, such as kerbing. To protect the rims, a protective rib or rim protector, is typically used. While this means of protection is admittedly effective, it is also expensive in terms of weight and manufacturing time. This type of assembly also exhibits sensitivity to shocks, particularly on the larger-diameter seat of the wheel situated on the inner side of the wheel.

In order to alleviate these various disadvantages, the invention provides an assembly comprising:
a vehicle wheel, with symmetry of revolution, comprising a disc and a rim, the said rim comprising a first and a second seat which seats are intended to receive and to hold a first and a second bead of the tire, each seat having a substantially frustoconical bottom locally coinciding with a cone of revolution coaxial with the rim and open towards the other seat, and an external flange extending the bottom of the said seat in the direction away from the other seat and comprising an outer portion, the said rim defining, at the level of an axial straight line passing through the farthermost points of the outer portions, a width Lj;
and, on the other hand, a tire for a vehicle wheel, comprising:
   two sidewalls spaced axially apart and defining, at the level of an axial straight line passing through the farthermost points of the said sidewalls, a width Lf, the said sidewalls each having, at the level of an axial straight line passing through the farthermost points of the said sidewalls, a width shorter than the width of the said sidewalls measured at a point substantially adjacent to the beads, the said sidewalls being connected to their radially outer portions by a crown region the width of which is shorter than the said width Lf and the said crown region being provided on its radially outer portion with a circumferential tread;
   beads, positioned radially internally with respect to each of the sidewalls, each bead comprising a seat and an external flange which are intended to come into contact with the said rim;
      a reinforcing structure extending substantially radially from each of the beads, along the sidewalls towards the crown region;
at least one of the said beads comprising:
   a bead seat comprising a generatrix, the axially inner end of which lies on a circle of diameter greater than the diameter of the circle on which the axially outer end lies;
   an anchoring region where the reinforcing structure is anchored in the said bead;
   the said assembly being arranged in such a way that, when the said tire is mounted on the said rim and inflated close to its nominal working pressure and when the said tire is substantially unflattened, (under no load or almost no load) the said width Lf is greater than the said width Lj (Lf>Lj).

By virtue of a configuration such as this, the assembly is protected from shocks by the protruding portion of the sidewalls. The tire of such an assembly has no sidewall insert (enabling it to withstand significant load in the event of significant or total loss of pressure) and therefore has rather thin sidewalls, giving the assembly good flexibility.

Advantageously, the maximum diameter of the first seat of the rim is less than the maximum diameter of the second seat of the rim.

According to an advantageous embodiment, the connecting region where the disc and the rim meet is connected to the said rim on the said second seat side. This reversal of the position of the two rim seats by positioning the larger-diameter seat, or second seat, on the outer side of the wheel, that is to say on the side connected to the disc, allows the larger-diameter region of the rim to be positioned in a very rigid region that is therefore far less sensitive to shocks than the seat on the inner side. This also has the advantage of making it possible to reduce the weight of the wheel because of the lower mechanical fatigue stresses applied to the inner seat or first seat. This embodiment makes it possible to obtain a good compromise in terms of load bearing capability and rigidity. Finally, this embodiment, for a standard size, allows a weight reduction that may be as much as 1.2 kg.

According to an advantageous alternative form, each seat comprises, on the side of the other seat, an adjacent circumferential groove, in which the said rim has, positioned between the said two grooves, a bearing surface of a diameter substantially equal to the maximum diameter of the said first seat. The circumferential grooves adjacent to the seats act as mounting grooves. These grooves are designed to allow the corresponding bead of the tire to get over the seat when the tire is being mounted on and/or removed from the rim. It should be noted that the groove adjacent to the larger-diameter second seat has a depth (Hₘₐₓ) designed to allow only the second bead of the tire to get over the second seat.

The assembly preferably comprises a tread support insert positioned around the said bearing surface of the rim. This insert allows the wheel to run over a given distance in a reduced-pressure or zero-pressure condition.

The wheels according to the invention are designed to be mounted using the method described for example in patent EP 1351832 B1. This mounting is performed by slipping the tire (and the support insert, if any) axially around the rim on the smaller-diameter first seat side until the second bead of the tire has got over the second seat of the rim. The tire is fitted into position using rotary mounting rollers which push the bead (and/or the insert) into place.

When the safety hump of the second seat has a region which is cylindrical of revolution or “ledge” of axial width L, the depth (Hₘₐₓ) of the groove adjacent to the second seat is dependent on the maximum diameter (Φ_{S2max}) of the second seat and of the axial width L of the ledge.

As a result, depending on the geometry and diameter of the second seat, the depth of the second circumferential groove may be equal to, smaller than or greater than that of the first circumferential groove.

Advantageously, the rim may, between the two grooves, have a bearing surface intended to accept a support insert.

If the same aspect, that is to say the same outer seat diameter visible when the assembly is mounted on a vehicle is maintained for the wheel/insert and tire assembly, then the wheel according to the invention has the advantage of having a bearing surface the diameter of which can be reduced appreciably, by the order of 20 mm with respect to the assemblies currently defined by the ETRTO (Standards Manual 2004, Rims, R. 14). That increases the clearance between the insert and the tread and thus reduces the magnitude of any loading liable to be transmitted to the vehicle in the event of a violent shock.

Advantageously, the bearing surface of the rim has a circumferential rib intended to lock the support insert in position, particularly when the axial dimension of this support insert occupies only an axial section of the area of rim between the two seats.

Advantageously, the insert comprises a support part positioned around the bearing surface of the rim and a locking part positioned radially externally relative to the second circumferential groove.

As a preference, with the second seat extended towards the first seat by a sidewall of the second circumferential groove, the insert is designed to bear against the sidewall of the second circumferential groove.

That allows the locking part of the insert to cooperate with the safety hump of the second seat of the rim to guarantee excellent unseating-prevention performance of the bead of the tire without adversely affecting the ability to mount and remove the tire.

As a preference, the assembly according to the invention is such that the bearing surface of the rim comprises a circumferential slot which cooperates with a plurality of wedges positioned circumferentially on the radially inner wall of the support insert in order to lock the insert in position on the bearing surface.

Other features and advantages of the invention will emerge from the description given hereinafter with reference to the attached drawings which, by way of non limiting examples, show some embodiments of the subject matter of the invention:

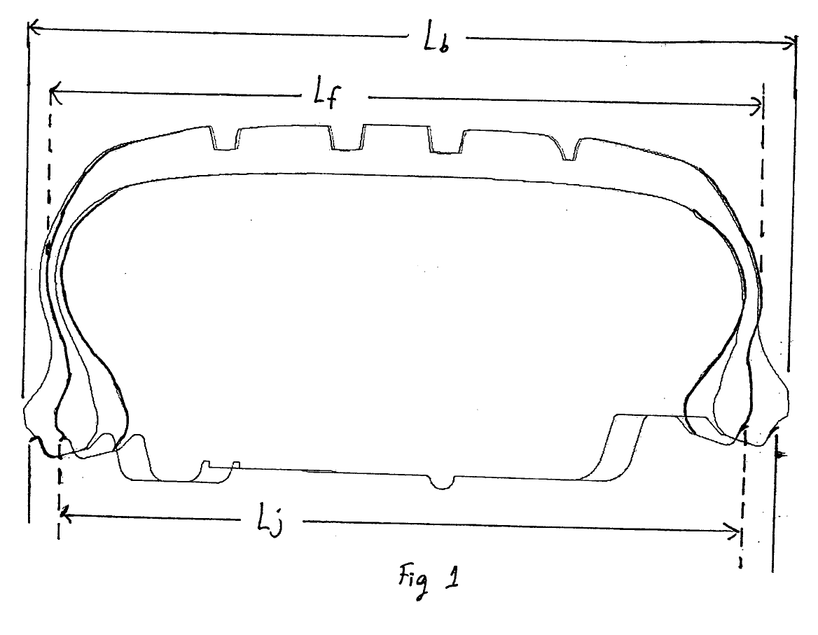

FIG. 1 shows a view in partial meridian section of a rim and tire assembly according to the invention, superimposed on an assembly of known type, of equivalent size, so as to show the differences in dimensional profile;

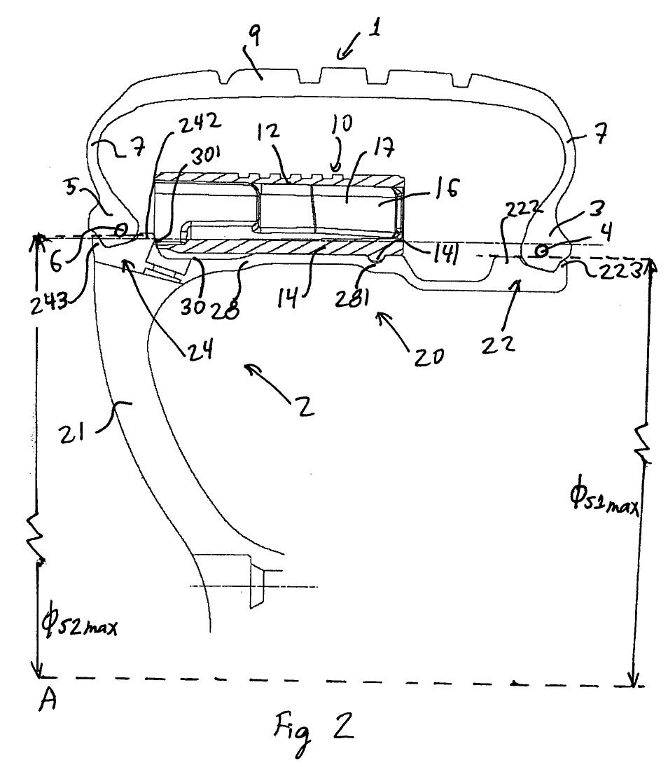

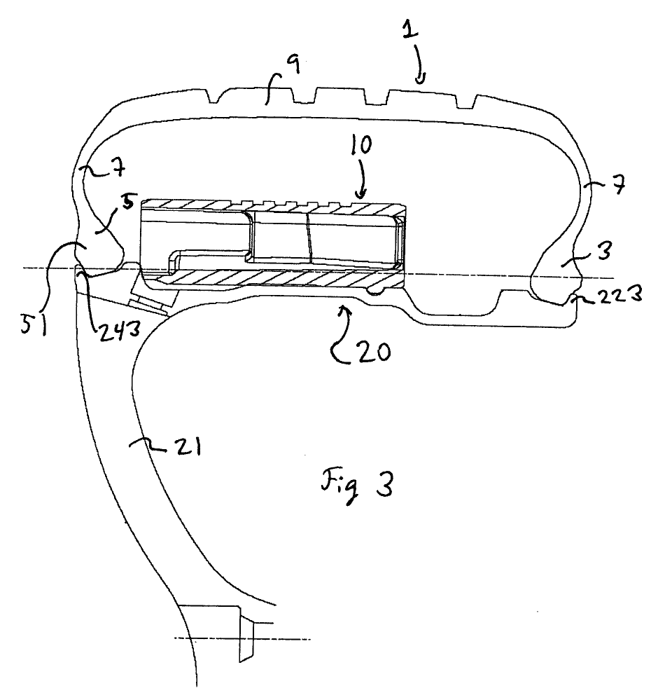

FIGS. 2 and 3 each show a view in partial meridian section of a rim and tire assembly according to the invention.

A meridian or axial plane is to be understood to mean any plane passing through the axis A of the wheel and of the rim.

FIG. 1 shows, viewed in partial meridian or axial section, an insert 10, rim 20 and tire 1 assembly according to the invention. The rim 20 forms, with a disc 21, a one-piece wheel 2. The disc may equally be manufactured independently of the rim and joined thereto thereafter. The rim 20 comprises a first seat 22 and a second seat 24 which seats are intended to act as bearing surfaces for the first 3 and second 5 beads of the tire 1.

The first seat 22 has a frustoconical bottom locally coinciding with a cone of revolution coaxial with the rim and open towards the second seat 24, a safety hump 222 extending the bottom of the first seat 22 towards the second seat 24, and an external flange 223 extending the bottom of the first seat on the opposite side to the second seat 24. The maximum diameter of the first seat 22 is Φ_{S1max}. This diameter corresponds to the maximum diameter of the safety hump 222.

The second seat 24 comprises a frustoconical bottom that locally coincides with a cone of revolution coaxial with the rim and open towards the first seat 22, a safety hump 242 extending the bottom of the second seat 24 towards the first seat 22 and an external flange 243 extending the bottom of the second seat on the opposite side to the first seat 22. The maximum diameter of the second seat 24 is Φ_{S2max}. This diameter corresponds to the maximum diameter of the safety hump 242.

According to the invention, a width Lj of the rim is defined using an axial straight line passing through the farthermost points of the opposing outer portions 223 and 243. These points being the points furthest towards the outside of the rim, it is these which are most exposed to shocks and external attack.

The maximum diameter of the second seat is greater than that of the first seat. In the example depicted, the order of magnitude of the difference between the maximum diameters Φ_{S2max}-Φ_{S1max} is of the order of 20 mm. The difference between the minimum radii of the two seats is therefore of the order of 10 mm.

From the first seat 22 towards the second seat 24 there are, in succession, a circumferential groove, a bearing surface 28 and a second circumferential groove 30. The second circumferential groove 30 acts as a mounting groove for the second seat 24. The groove 30 has a sidewall 301 adjacent to the safety hump 242. On the bearing surface 28 there is a circumferential groove 281. The outside diameter of the bearing surface 28 substantially corresponds to the maximum diameter of the first seat 22 so as to allow the insert 10 to be slipped onto this bearing surface 28 having got over the first seat 22.

The tire 1 comprises two beads 3 and 5 intended to bear against the seats 22 and 24 of the rim 20, two sidewalls 7 and a tread 9. Each bead has annular reinforcements directed substantially circumferentially and which are practically inextensible. These reinforcements, such as bead wires 4 and 6, are intended, in service, to hold the beads on the rim seats.

The tire has a reinforcing structure of the carcass type, provided with reinforcements advantageously configured in a substantially radial arrangement. This structure may be arranged continuously from one bead to the other, passing through the sidewalls and the crown region, or alternatively may be made up of two or more parts, arranged for example along the sidewalls, without covering the entirety of the crown region.

The end portions of the reinforcing structure are situated in the beads. Each bead has a seat and an external flange which are intended to come into contact with a suitable rim: to improve running in degraded mode, the bead seat has a generatrix, the axially inner end of which lies on a circle of diameter greater than the diameter of the circle on which the axial outer end lies.

Each bead also comprises a substantially circumferential anchoring region. According to a first embodiment which is conventionally known, the anchoring region comprises a bead wire around which the end portion of the reinforcing structure is wrapped. The bead wire is intended, on the one hand, to anchor the reinforcing structure and, on the other hand, to clamp the tire when this tire is mounted on an appropriate rim.

According to an alternative form of embodiment, the anchoring region is produced in some way other than by wrapping around a bead wire. According to this alternative form, also of a known type, the anchoring region comprises an arrangement of circumferential threads arranged substantially adjacent to a portion of the reinforcing structure. The said anchoring region comprises at least two piles which are distributed on each side of the reinforcing structure, a bonding (or anchoring) compound being deposited between the circumferential threads and reinforcing structure.

In the anchoring region, the space between the threads and reinforcing structure is filled with a rubber bonding compound. It is also possible to envisage the use of several compounds with different characteristics, delimiting several regions, the combinations of compound and the resulting arrangements being practically unlimited. According to various alternative forms of embodiment, use is made of rubber bonding compounds with a panoply of moduli: by way of nonlimiting example, the elastic modulus may range between 10 and 20 MPa, or even have higher values such as 40 MPa or more.

The arrangements of threads may be arranged and manufactured differently. For example, one pile may advantageously consist of a single thread, wound (at practically zero degrees) in a spiral, preferably from the smaller diameter to the larger diameter. One pile may also consist of several concentric threads placed one inside the other.

The two sidewalls 7 are spaced axially apart and, with the aid of an axial straight line passing through the farthermost points of these sidewalls, define a width Lf.

According to the invention, when the said tire is mounted on the said rim and inflated to a pressure close to its nominal working pressure, the said width Lf is greater than the said width Lj of the rim (Lf>Lj). This then protects the rim, particularly the outer portions 223 and 243 which are the most exposed and which it would therefore be desirable to be able to protect from any attack that might damage the rim or at least adversely affect its visual appearance. This protection at the same time allows the entire rim to be protected. This type of configuration with Lf>Lj is advantageously obtained by reducing the width of the rim by comparison with a conventional configuration. For example, on an assembly of a standard size, the reduction in width by comparison with a conventional rim may be of the order of 20 mm. As a preference, the width is reduced by 3 to 15% and sometimes more. Thus, whereas in a conventional configuration, the widest region corresponds to the width Lb, namely the width between the rim protectors, according to the invention, the widest region is at Lf, namely the width between the sidewalls. It is therefore the sidewalls which protect the wheel against shocks. Thus, as shown in FIG. 3, in order to derive maximum advantage from this arrangement, it is possible to provide a lighter bead 51 with a substantially straight external profile, that is to say without a rim protector. The omission of the protective rib allows the assembly to be lightened.

According to a preferred embodiment, as depicted in FIG. 2, it can be seen that the disc 21 is connected to the rim 20 on the second rim seat 24 side, that is to say on the larger diameter seat side. The safety hump 242 of the seat 24 is the largest diameter part of the rim. It is therefore this part which is the most heavily mechanically loaded when the wheel is kerbed or passes over a pothole. This region thus lies adjacent to the connection between the disc 21 and the rim 20 and therefore has high rigidity favoring excellent mechanical resistance to shocks. The first rim seat is also less heavily mechanically loaded in comparison to wheels of the prior art: that allows the thickness of the rim to be reduced in this region and thus the overall mass of the wheel to be reduced. By comparison with a wheel with the same outer seat or second seat diameter, a mass saving of as much as 20% can be achieved.

The assembly according to the invention may comprise an insert 10. This essentially comprises;

a substantially cylindrical crown region 12 intended to come into contact with the tread 9 of the tire 1 in the event of a loss of pressure, but leaving clearance with respect to this tread at nominal pressure,

a substantially cylindrical sole 14 intended to fit around the rim 20, this sole comprising a plurality of wedges 141 positioned circumferentially, of substantially semi-cylindrical cross section and intended to collaborate with the groove 281 to lock the insert 10 in position on the bearing surface 28 of the rim 20, and

an annular body 16 connecting the sole 14 and the crown region 12, this body comprising a collection of Y-shaped partitions substantially radially connecting the sole and the crown region and directed substantially axially from one side of the insert to the other.

The sole 14 comprises circumferentially directed reinforcements such as steel threads or high-modulus textile reinforcements such as aramid. Their function is to oppose the centrifugal forces experienced by the insert during high-speed running to allow the insert to remain bearing against the bearing surface without shifting circumferentially. These reinforcements, which have not been depicted in the figure, are positioned axially on each side of the housing 40.

The fact of having a support insert that comes to bear against the sidewall 301 of the groove 30 adjacent to the safety hump 242 makes it possible to substantially reduce the width of the hump 242 relative to the frustoconical bottom of the seat 24. This then makes it possible to reduce the depth of the circumferential groove 30 accordingly without adversely affecting the ability to mount and to remove the tire. This depth of the circumferential groove 30, the function of which is also to allow the bead 5 of the tire 1 to get over the seat 24, may range between 10 and 15 mm and preferably between 12 and 13 mm.

The invention is not restricted to the examples described and depicted and various modifications can be made thereto without departing from its scope which is limited only by the claims which follow.

We claim:

1. An assembly comprising:
a vehicle wheel, with symmetry of revolution, comprising a disc and a rim, the said rim comprising a first and a second seat which seats are intended to receive and to hold a first and a second bead of the tire, each seat having a substantially frustoconical bottom locally coinciding with a cone of revolution coaxial with the rim and open towards the other seat, and an external flange extending the bottom of the said seat in the direction away from the other seat and comprising an outer portion, the said rim defining, at the level of an axial straight line passing through the farthermost points of the outer portions, a width Lj;
and, on the other hand, a tire for a vehicle wheel, comprising:
two sidewalls spaced axially apart and defining, at the level of an axial straight line passing through the farthermost points of the said sidewalls, a width Lf, the said sidewalls each having, at the level of an axial straight line passing through the farthermost points of the said sidewalls, a width shorter than the width of the said sidewalls measured at a point substantially adjacent to the beads, the said sidewalls being connected to their radially outer portions by a crown region the width of which is shorter than the said width Lf and the said crown region being provided on its radially outer portion with a circumferential tread;
beads, positioned radially internally with respect to each of the sidewalls, each bead comprising a seat and an external flange which are intended to come into contact with the said rim;
a reinforcing structure extending substantially radially from each of the beads, along the sidewalls towards the crown region;
at least one of the said beads comprising:
a bead seat comprising a generatrix, the axially inner end of which lies on a circle of diameter greater than the diameter of the circle on which the axially outer end lies;
an anchoring region where the reinforcing structure is anchored in the said bead;
wherein, when the said tire is mounted on the said rim and inflated close to its nominal working pressure and when the said tire is substantially unflattened, said width Lf is greater than the said width Lj.

2. The assembly of claim 1, in which the maximum diameter of the first seat of the rim is less than the maximum diameter of the second seat of the rim.

3. The assembly of claims 1 or 2, in which the connecting region where the disc and the rim meet is connected to the said rim on the said second seat side.

4. The assembly of claim 1, in which each seat comprises, on the side facing the other seat, an adjacent circumferential groove, and in which the said rim has, positioned between the said two grooves, a bearing surface of a diameter substantially equal to the maximum diameter of the said first seat.

5. The assembly of claim 1, further comprising a tread support insert, in which the said support insert is positioned around the said bearing surface of the rim.

6. The assembly of claim 1, in which the said support insert extends axially as far as the second seat.

7. A tire for a vehicle wheel, specially designed for use with an assembly according to one of the preceding claims, the said tire comprising:
two sidewalls spaced axially apart and defining, at the level of an axial straight line passing through the farthermost points of the said sidewalls, a width Lf, the said sidewalls each having, at the level of an axial straight line passing through the farthermost points of the said sidewalls, a width shorter than the width of the said sidewalls measured at a point substantially adjacent to the beads, the said sidewalls being connected to their radially outer portions by a crown region the width of which is shorter than the said width Lf and the said crown region being provided on its radially outer portion with a circumferential tread;
beads, positioned radially internally with respect to each of the sidewalls, each bead comprising a seat and an external flange which are intended to come into contact with the said rim;
a reinforcing structure extending substantially radially from each of the beads, along the sidewalls towards the crown region;
at least one of the said beads comprising:
a bead seat comprising a generatrix, the axially inner end of which lies on a circle of diameter greater than the diameter of the circle on which the axially outer end lies;
an anchoring region where the reinforcing structure is anchored in the said bead.
